(19) United States
(12) Patent Application Publication
(10) Pub. No.: US 2009/0055155 A1
(43) Pub. Date: Feb. 26, 2009

(54) SIMULATING EXECUTION OF SOFTWARE PROGRAMS IN ELECTRONIC CIRCUIT DESIGNS

(76) Inventors: Russell Klein, West Linn, OR (US); Marc Minato, West Linn, OR (US)

Correspondence Address: KLARQUIST SPARKMAN, LLP, 121 S.W. SALMON STREET, SUITE 1600, PORTLAND, OR, 97204, US

(21) Appl. No.: 11/841,690

(22) Filed: Aug. 20, 2007

(51) Int. Cl. G06F 9/45

(52) U.S. Cl. 703/22

(57) ABSTRACT

In some embodiments disclosed herein, the execution of a software program by processor can be simulated using two models of the processor: one “detailed” model that offers a relatively high level of detail and operates relatively slowly; and another “fast” model that offers a relatively low level of detail and operates relatively quickly. Portions of the software program are simulated as being executed on one model or the other according to simulation selection information (e.g., user input). State information is passed between models as the system switches from one model to another. The detailed model can comprise, for example, a “full functional” processor model, while the fast model can comprise, for example, an instruction set simulator (ISS) and a bus cycle engine (BCE). Further embodiments allow a plurality of software programs to be simulated in batch using the disclosed technologies.

### FIELD

The disclosed technologies relate to conducting simulations of software and electronic circuit designs.

### BACKGROUND

During product development, simulation systems (e.g., hardware-software co-verification systems) can be useful in testing the execution of a software program by an electronic circuit design comprising, for example, a processor. Generally, simulation systems employ a model of the processor. However, sometimes users of such systems must choose between simulating execution of the program at a relatively slow speed and obtaining results with a relatively high level of detail or simulating execution of the program at a relatively high speed but obtaining results with a relatively low level of detail.

### SUMMARY

In some embodiments disclosed herein, the execution of a software program by a processor can be simulated using a combination of two models of a microprocessor or microcontroller which is part the circuit design: one “detailed” model that offers a relatively high level of detail and operates relatively slowly; and another “fast” model that offers a relatively low level of detail and operates relatively quickly. Portions of the software program are simulated as being executed on one model or the other according to simulation selection information (e.g., user input). State information is passed between models as the system switches from one model to another. The detailed model can comprise, for example, a “full functional” processor model, while the fast model can comprise, for example, an instruction set simulator (“ISS”) and a bus cycle engine (“BCE”).

In some embodiments, a method of simulating execution of a software program by a processor having one or more output pins comprises: simulating execution of a first portion of the software program using a first model of the processor, wherein the first model operates with a first degree of abstraction of the processor and is configured to simulate generation of a first set of signals on the one or more output pins; simulating execution of a second portion of the software program using a second model of the processor, wherein the second model operates with a second degree of abstraction of the processor and is configured to simulate generation of a second set of signals on the one or more output pins, and wherein the first degree of abstraction is more abstract than the second degree of abstraction; and storing at least a portion of the first or second set of signals on the one or more output pins in one or more computer-readable media. The method can further comprise passing state information between the first model of the processor and the second model of the processor. In particular embodiments, the passing of state information occurs when the second model of the processor is not simulating the execution of an instruction that affects one or more hardware components external to the second model. In additional embodiments, the passing of state information comprises loading data from the first model of the processor into storage locations of the second model of the processor. In some cases the passing of state information further comprises: resetting the second model of the processor to a known state; and setting a program counter in the second model of the processor to a selected value. In some embodiments the method further comprises providing to the first model of the processor information about one or more operations performed by the second model of the processor during the simulating of the second portion of the software program. For particular embodiments, the first level of abstraction disregards at least some clock-edge timing information for the processor. The method can further comprise reading state information from the second model of the processor using an instruction set simulator; and providing the state information from the instruction set simulator to the first model of the processor. In further embodiments the method also comprises identifying the first portion of the software program and the second portion of the software program based at least in part on user input. The method can also comprise displaying the first or second set of signals on the one or more output pins to a user. In some embodiments the displaying comprises determining that a value in a selected storage location will change from a first value to a second value within a predetermined number of clock cycles, and displaying the second value. The processor is sometimes simulated as being coupled to one or more components in an electronic circuit design.

In a further embodiment, a system for simulating execution of a software program in a processor comprising one or more output pins comprises: a first model of the processor configured to simulate execution of the software program at a first level of detail, wherein the first model of the electronic circuit is configured to simulate signals produced by the processor at the one or more output pins; a second model of the processor configured to simulate execution of the software program at a second level of detail, wherein the second model of the electronic circuit is configured to simulate signals produced by the processor at the one or more output pins; and a software component configured to display the one or more results produced according to the first model or the second model. In some embodiments the system further comprises a simulation selection component configured to receive an indication of whether execution of a portion of the software program is to be simulated according to the first model of the processor or the second model of the processor, and sometimes furthermore comprises a remote computer, wherein the simulation selection component is configured to receive the indication from the remote computer over a network. In particular embodiments the processor comprises an instruction set simulator and a bus cycle engine. In some embodiments, the bus cycle engine simulates completion of execution of a first-bus-cycle address phase and a first-bus-cycle data phase before simulating beginning of execution of a second-bus-cycle address phase or a second-bus-cycle data phase. In additional embodiments the second model of the processor comprises a register transfer level or gate level model. The first model of the processor is configured to simulate the execution of the software program at the rate of at least about 1 million instructions per second.

In a further embodiment, one or more computer-readable media comprise comprising instructions configured to cause a computer to perform a method comprising: receiving input from a user that execution of a first portion of a software program by a processor is to be simulated at a first level of detail and that execution of a second portion of the software program is to be simulated at a second level of detail; simulating the execution of the first portion of the software program at the first level of detail using a first model of the processor; simulating the execution of the second portion of the software program at the second level of detail using a second model of the processor; and storing at least a portion of the results of the simulations of the executions of the first or second portions in one or more computer-readable media. In further embodiments, the one or more computer-readable media further comprise instructions configured to cause the computer to perform the method for each of a plurality of software programs.

In particular embodiments, a method of simulating operation of a processor comprises: receiving state information from a first processor model; loading the state information into one or more storage locations in a second processor model; and simulating executing a portion of a software program on the second processor model. In some embodiments the second processor model comprises a pipeline, the method further comprising simulating executing one or more instructions to flush the pipeline. The simulating executing one or more instructions to flush the pipeline sometimes comprises simulating executing one or more no-op instructions. In further embodiments the method comprises resetting the second processor model to a known state. In additional embodiments the method further comprises setting a program counter in the second processor model.

In a further embodiment, a method of analyzing execution of a software program by a processor comprises: executing a first portion of the software program using equivalent hardware to generate a first set of output data; transferring processor context information between the equivalent hardware and a model of the processor; simulating execution of a second portion of the software program using the model of the processor, wherein the second model operates with a degree of abstraction of the processor and is configured to simulate generation of a second set of output data; and storing at least a portion of the first or second set of output data in one or more computer-readable media. In some cases the equivalent hardware comprises the processor in a host computer, while in some cases the equivalent hardware comprises an emulator.

Further embodiments comprise one or more computer-readable media comprising signals and/or data produced using one or more of the foregoing embodiments. In additional embodiments, one or more computer-readable media comprise instructions configured to cause a computer to perform one or more of the above method embodiments.

The foregoing and other features and advantages of the disclosed technologies will become more apparent from the following detailed description, which proceeds with reference to the accompanying figures.

### BRIEF DESCRIPTION OF THE DRAWINGS

FIG. 1 is a schematic block diagram of an exemplary embodiment of a system for simulating the execution of a software program on an electronic circuit design.

FIG. 2 is a block diagram of an exemplary embodiment of a method for simulating the execution of a software program in a processor.

FIGS. 3 and 4 show exemplary embodiments of the operation of the method of FIG. 2 with the system of FIG. 1.

FIG. 5 is a block diagram of an exemplary embodiment of a method for transferring state information from a fast processor model to a detailed processor model.

FIG. 6 shows a pseudocode example of one embodiment of a computer program that can be used to perform at least a portion of the method shown in FIG. 7.

FIG. 7 shows a diagram of examples of relations between address cycles and data cycles in one embodiment of a bus cycle engine.

FIG. 8 shows a diagram of examples of relations between address cycles and data cycles in one embodiment of a bus cycle engine.

FIG. 9 is a schematic block diagram of a network as can be used to perform any of the disclosed methods.

FIG. 10 is a schematic block diagram of a distributed computing network as can be used to perform any of the disclosed methods.

FIG. 11 is a flowchart illustrating how a simulation using the disclosed technologies can be performed using the network of FIG. 9 or FIG. 10.

FIG. 12 is a schematic block diagram of an exemplary embodiment of a system for simulating the execution of a software program on an electronic circuit design.

### DETAILED DESCRIPTION

Disclosed below are representative embodiments of methods, apparatus, and systems for simulating the execution of a software program in an electronic circuit design that should not be construed as limiting in any way. Instead, the present disclosure is directed toward all novel and nonobvious features and aspects of the various disclosed methods, apparatus, and systems, alone and in various combinations and subcombinations with one another. The disclosed technology is not limited to any specific aspect or feature, or combination thereof, nor do the disclosed methods, apparatus, and systems require that any one or more specific advantages be present or problems be solved.

Although the operations of some of the disclosed methods are described in a particular, sequential order for convenient presentation, it should be understood that this manner of description encompasses rearrangement, unless a particular ordering is required by specific language set forth below. For example, operations described sequentially may be rearranged or performed concurrently. Moreover, for the sake of simplicity, the attached figures may not show the various ways in which the disclosed methods, apparatus, and systems can be used in conjunction with other methods, apparatus, and systems. Additionally, the description sometimes uses terms like “determine,” “analyze” and “identify” to describe the disclosed technologies. These terms are high-level abstractions of the actual operations that are performed. The actual operations that correspond to these terms can vary depending on the particular implementation and are readily discernible by one of ordinary skill in the art.

As used in this application and in the claims, the singular forms “a,” “an” and “the” include the plural forms unless the context clearly dictates otherwise. Additionally, the term “includes” means “comprises.” Moreover, unless the context dictates otherwise, the term “coupled” means electrically or electromagnetically connected or linked and includes both direct connections or direct links and indirect connections or indirect links through one or more intermediate elements not affecting the intended operation of the circuit. The phrase “and/or” means “and,” “or,” and “both.”

In at least some of the embodiments described below, when an operation is described as being performed on an electronic circuit design or on a processor, this can mean that during a simulation of the design or processor, the operation is simulated as being performed on the circuit described by the circuit design or processor. For example, if a value is described as being “written” to the circuit or the circuit design or processor, this can refer to the value being simulated as written to the circuit described by the design or processor.

The disclosed embodiments can be implemented in a wide variety of environments. For example, any of the disclosed techniques can be implemented in software comprising computer-executable instructions stored on computer-readable media (e.g., one or more CDs, volatile memory components (such as DRAM or SRAM), or nonvolatile memory components (such as hard drives)). Such software can comprise, for example, electronic design automation (“EDA”) software (e.g., a logic simulator tool or a software debugger) used to simulate the execution of software during simulation and/or testing of one or more circuit designs (e.g., an application-specific integrated circuit (“ASIC”), a programmable logic device (“PLD”) such as a field-programmable gate array (“FPGA”), or a system-on-a-chip (“SoC”) having digital, analog, or mixed-signal components thereon). This particular software implementation should not be construed as limiting in any way, however, as the principles disclosed herein are generally applicable to other software tools.

Such software can be executed on a single computer or on a networked computer (e.g., via the Internet, a wide-area network, a local-area network, a client-server network, or other such network). For clarity, only certain selected aspects of the software-based implementations are described. Other details that are well known in the art are omitted. For example, it should be understood that the disclosed technologies are not limited to any specific computer language, program, or computer. For the same reason, computer hardware is not described in further detail. For example, the disclosed embodiments can be implemented using a wide variety of commercially available computer systems and/or simulation systems. Components of system embodiments described herein can be implemented as one or more hardware and/or software components. Any of the disclosed methods can alternatively be implemented (partially or completely) in hardware (e.g., an ASIC, PLD, or SoC).

For presentation purposes the present disclosure sometimes refers to a system or system components by their physical counterpart (for example, multiplexers, demultiplexers, memories, registers and other such terms). It should be understood, however, that any reference in the disclosure or the claims to a physical component includes representations of such circuit components as are used in simulation environments.

Further, simulation results (e.g., events simulated as occurring in an electronic circuit design or processor, including values simulated as being stored in the design or processor, as well as any intermediate simulation results) produced from any of the disclosed methods can be created, updated, or stored on computer-readable media (e.g., one or more CDs, volatile memory components (such as DRAM or SRAM), or nonvolatile memory components (such as hard drives)) using a variety of different data structures or formats. For example, a list of software instructions or memory values can be stored on one or more computer-readable media. Such simulation results can be created or updated at a local computer or over a network (e.g., by a server computer).

Exemplary embodiments of systems for analyzing hardware and software are described in: U.S. Pat. No. 5,768,567 to Klein et al., issued Jun. 19, 1998, and titled “Optimizing Hardware and Software Co-Simulator”; and U.S. Pat. No. 5,771,370 to Klein, issued Jun. 23, 1998, and titled “Method and Apparatus for Optimizing Hardware and Software Co-Simulation,” both of which are incorporated herein by reference. The technologies described in this disclosure can be used in combination with one or more technologies described in these patents.

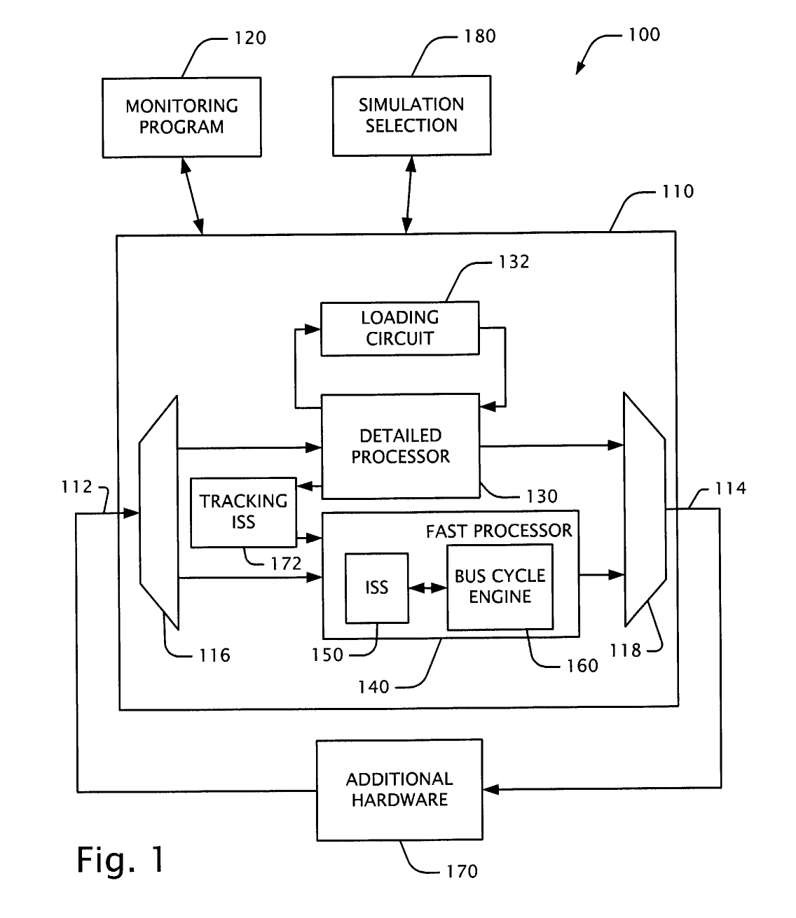

FIG. 1 shows a schematic block diagram of one embodiment of a system 100 for simulating the execution of a software program on an electronic circuit design. In some embodiments, the elements depicted in FIG. 1 comprise models of hardware simulated in software (e.g., in a logic simulator). In further embodiments, one or more of the elements are implemented at least partly in actual hardware. The system 100 comprises a processor model 110 that, in some embodiments, is coupled to one or more additional hardware models 170 as well as a monitoring program 120 configured to receive and/or display simulation results from the processor model 110. The processor model 110 is designed to simulate the operation of a processor (e.g., a processor from ARM, Inc., or Intel Corporation) or other circuit that can execute software instructions in the electronic circuit design. In some embodiments, the monitoring program 120 can be a software debugger, a logging program, or other software component used for displaying, storing and/or examining results of an electronic circuit design simulation. The processor model 110 can be configured to receive inputs and outputs, as shown generally at input bus 112 and output bus 114. In some embodiments, the busses 112, 114 are coupled to the additional hardware models 170 and/or additional software components (not shown) which are part of the simulated circuit design.

In some embodiments, the processor model 110 simulates the operation of a processor using two processor models, a first processor model 130 and a second processor model 140. The models 130, 140 simulate the execution of one or more software instructions by the processor in the electronic circuit design including, for example, the effects of such instructions on values stored in memory elements in the circuit design, or the effects of such instructions on signals on one or more input and/or output buses of the circuit design.

As is further explained below, in some embodiments the first processor model 130 provides a more detailed simulation of the operation of the processor relative to the second processor model 140. Generally, the two models 130, 140 are of differing levels of abstraction of the processor. For example, in some embodiments the first processor model 130 is a “full functional model” or “very detailed model” that can exhibit some or all documented timing and functionality of the actual processor as implemented in silicon. In particular embodiments, the model 130 is modeled at the register transfer level (“RTL”) and models the behavior of most or all registers, latches and interconnects that make up the processor. In further embodiments, the model 130 is modeled at the gate level and models the behavior of most or all individual electronic gates and interconnects that make up the processor. In some embodiments the model 130 can provide information such as clock-edge timing details for one or more signals. In some cases, models such as the first processor model 130 are developed and made available by a vendor that creates the processor, while in some cases they are developed by one or more other parties. In some embodiments, these models can simulate the execution of instructions at rates of about 10 instructions per second. In additional embodiments, the first processor model 130 does not completely specify internal structural implementation details of the processor but specifies at least some of the details.

The second processor model 140, on the other hand, can be configured to provide a faster simulation of the operation of the processor relative to the first processor model 130. In some embodiments the model 140 can simulate the execution of software instructions on the processor and provide, at an architectural level, the same results as the actual processor. Although the second processor model 140 generally does not provide information such as clock-edge timing details, some embodiments of the model 140 can simulate the execution of instructions at rates faster (e.g., on the order of 1,000,000 times or more faster) than the first processor model 130. In various embodiments, the second processor model 140 can simulate the execution of instructions at rates, for example, of about 10 to 100 million instructions per second. In additional embodiments the second processor model 140 executes instructions at lower or higher rates.

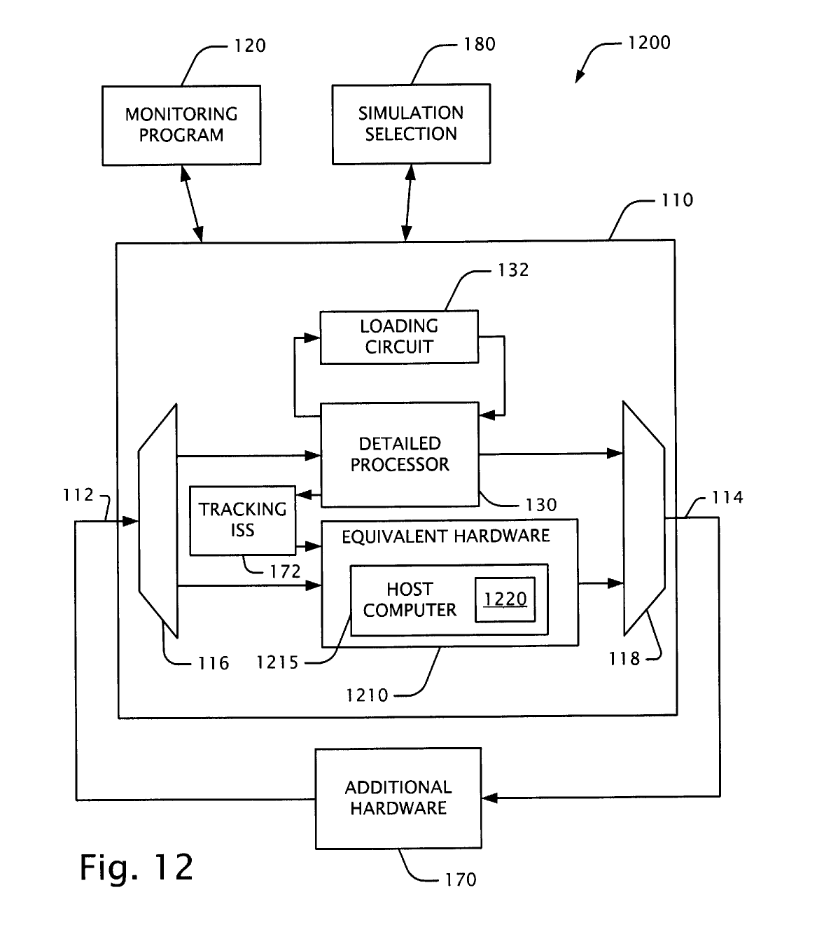

FIG. 12 depicts a further embodiment 1200 of the system 100. In such embodiments, the second processor model 140 is replaced by equivalent hardware 1210. The equivalent hardware 1210 can be implemented, for example, by porting some or all of the software instructions to a processor 1220 on a host computer 1215. This allows the software instructions to be run on equivalent hardware such as an actual processor, rather than a simulated processor. Generally, the processor 1220 executes the software instructions at a faster rate than the execution of the instructions can simulated. In some embodiments the model 1200 sends the software instructions to the host computer 1210 through, for example, a host code execution (HCE) interface (not shown). In further embodiments, the equivalent hardware 1210 can be implemented using an FPGA or other reconfigurable computing device, and/or an emulator. In additional embodiments, the detailed processor 130 is also implemented using equivalent hardware such as an FPGA or other reconfigurable computing device, and/or an emulator.

Returning to FIG. 1, the first processor model 130 is sometimes referred to herein as the “detailed processor model 130” and the second processor model 140 is sometimes referred to herein as the “fast processor model 140.” Additional embodiments comprise one or more processor models, which operate with varying degrees of abstraction, in addition to the models 130, 140.

In particular embodiments, the detailed processor model 130 and the fast processor model 140 can be coupled to the input bus 112 and the output bus 114 through a demultiplexer 116 and a multiplexer 118, respectively. Furthermore, in some embodiments the detailed processor model 130 and the fast processor model 140 are coupled to a tracking instruction set simulator (“tracking ISS”) 172, whose function is described in more detail below.

In some embodiments, the fast processor model 140 can comprise an ISS 150 and a bus cycle engine 160. The ISS 150 can be constructed for use in modeling a processor based on information such as a description of the processor's instruction set and the effects of the instructions on registers and/or memories. In at least some cases, the ISS 150 can be constructed at the needed level of abstraction from a data book or other description of the processor by the party that designed the processor and/or by another party. The data book or other description is often available publicly, which is sometimes advantageous from a business and/or a practical point of view. A data book comprises, for example, descriptions of the processor's architecture, instruction set, pin layout, input/output signals and other information. The ISS 150 generally models primary, programmer-visible registers of the processor and the processor's memory storage elements. From a functional standpoint, generally the ISS 150 simulates events such as changes in register values and changes in memory values in response to one or more inputs, although further embodiments can track additional and/or other values. In further embodiments, a bus interface model (BIM) can be used in place of the BCE 160. A BCE or BIM can sometimes be created based on one or more descriptions of the processor which is being modeled as part of the simulated electronic circuit design (e.g., from a data book or other description). Generally, the BCE 160 translates an operation, whose execution is the result of an instruction which is being executed by the ISS 150, into a simulated sequence of pin- and/or signal-level interactions that occur, for example, with the additional hardware models 170. Examples of such operations include a read operation from, or a write operation to, a memory. Details of various embodiments of the BCE 160 are discussed below.

Further embodiments can also comprise a simulation selection component 180, which can be used to determine whether the processor model 110 provides circuit simulation results according to the detailed processor model 130 or the fast processor model 140. The component 180 can receive inputs from, for example, a user interface, a programming script, or from one or more other sources. In some embodiments the component 180 receives inputs indicating that the execution of a first portion of a software program is to be simulated using the detailed processor model 130 and a second portion of the software program is to be simulated using the fast processor model 140. Generally, those of ordinary skill in the art are familiar with how to model components such as demultiplexer 116, multiplexer 118, the additional hardware models 170 and loading circuit model 132. Additionally, those of ordinary skill in the art are familiar with monitoring programs, such as monitoring program 120. Accordingly, the implementation of these models and programs is not described in further detail.

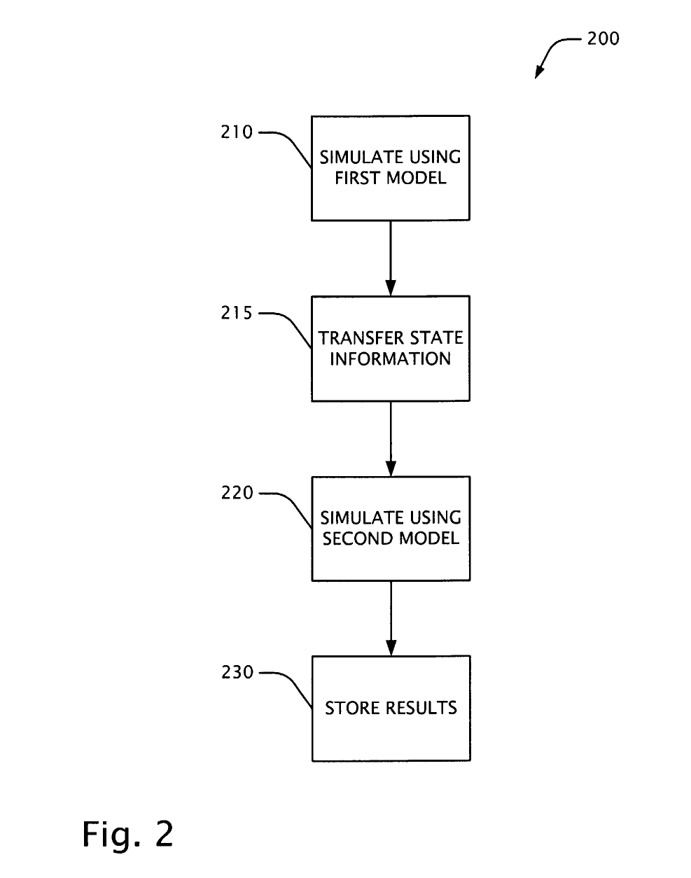

FIG. 2 shows one embodiment of a method 200 for simulating the execution of a software program in processor using a system such as the system 100. In a method act 210, at least a portion of the execution of the program is simulated on a first model (e.g., one of the detailed processor model 130 or the fast processor model 140). In method act 220, at least a portion of the execution of the program is simulated on a second model (e.g., the other of the detailed processor model 130 or the fast processor model 140), and in a method act 230 at least some simulation results are stored in one or more computer-readable media (e.g., by a recording component or other software component). These results can be observed by the monitoring program 120, for example. In at least some embodiments state information, explained in more detail below, is passed from the first model to the second model in a method act 215, as explained below.

The state information is sometimes referred to as a processor's “architectural state” or, in the real-time operating system field, “processor context information.” In various embodiments it includes: contents of one or more general purpose and/or special purpose registers (e.g., program counter (PC), stack pointer (SP), R0, R1, R2, etc.); contents of one or more coprocessor registers (e.g., tightly coupled memory (TCM) status registers, memory management unit (MMU) control registers, cache control registers); contents of internal CPU memories (e.g., caches, TCM unflushed write buffers); and/or any additional registers, particularly registers that affect the execution of the program. While some processors comprise millions of registers, the architectural state of a given register may comprise the contents of, for example, only a few dozen of those registers. In at least some embodiments, the architectural state is sufficient to restore in a processor a program or set of programs (for example, in the context of a computer operating system) from which they can correctly continue operation.

According to some embodiments of the method 200, a system such as the system 100 simulates the execution of a first portion of a software program on the processor, corresponding to the method act 210 of the method 200. Based on one or more inputs received by the simulation selection component 180, the fast processor model 140 is used to simulate execution of this first portion of the software program. The fast processor model 140 is configured to receive inputs from the input bus 112 and provide outputs to the output bus 114, via the demultiplexer 116 and the multiplexer 118 respectively.

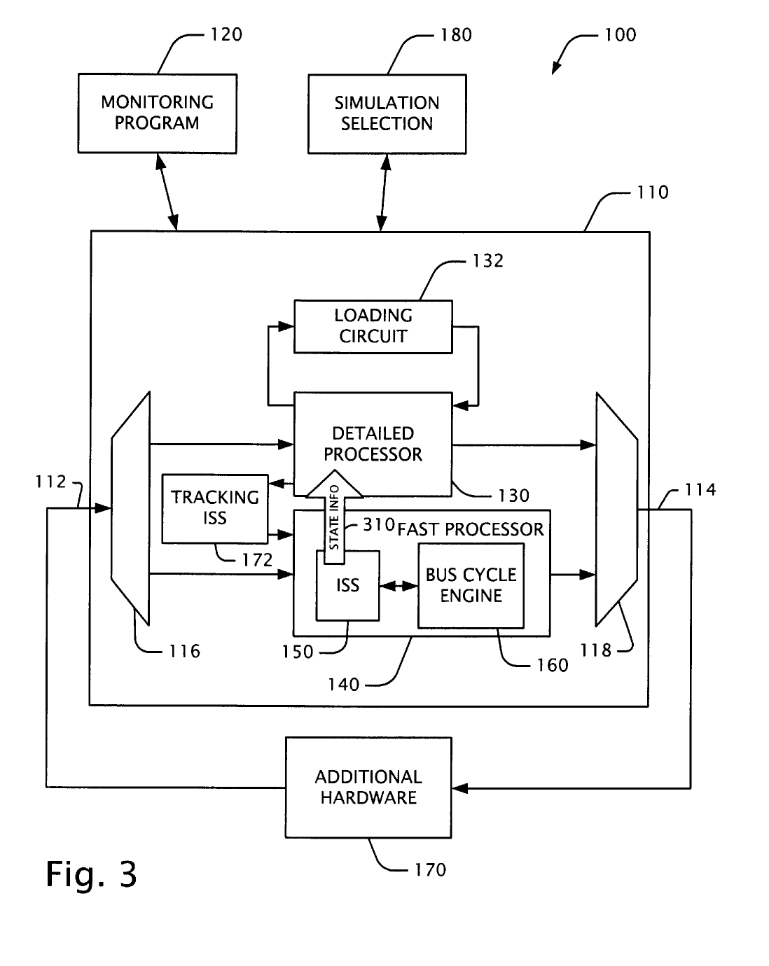

FIG. 3 depicts state information 310 being transferred from the fast processor model 140 to the detailed processor model 130, corresponding to the method act 215 of the method 200. The ISS 150 includes functionality for reading from and/or writing to registers, internal memories, and/or other locations.

The system 100 simulates the execution of a second portion of the software program on the processor, corresponding to the method act 220 of the method 200. According to one or more inputs received using the simulation selection component 180, the detailed processor model 130 is used to simulate execution of this first portion of the software program. Accordingly, the detailed processor model 130 is configured to receive inputs from the input bus 112 and provide outputs to the output bus 114, via the demultiplexer 116 and the multiplexer 118, respectively.

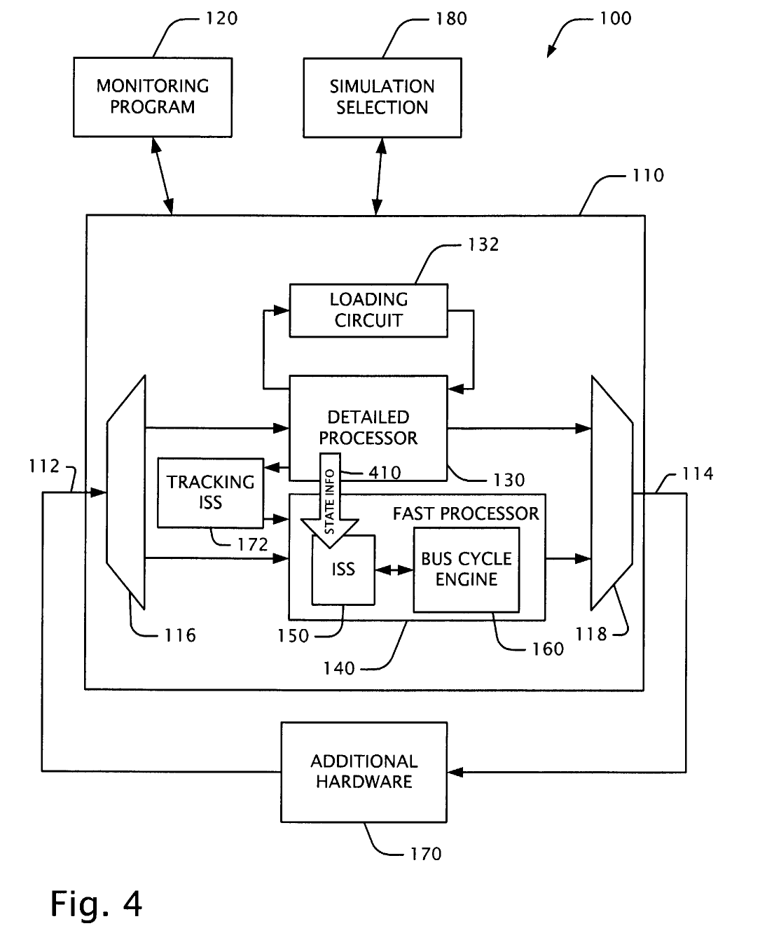

FIG. 4 shows the system 100 transferring state information 410 from the detailed processor model 130 to the fast processor model 140.

In some embodiments, state information 410 is extracted from the detailed processor model 130 for transfer to the fast processor model 140 by interrupting the detailed processor model 130 and copying the contents of one or more registers or other memory locations into a memory location accessible to the fast processor model 140. However, in some cases it can be difficult to reliably interrupt an executing program and then cause the detailed processor model 130 to execute a different set of instructions.

In certain embodiments, state information is extracted from the detailed processor model 130 using debug facilities of the model 130. For example, the Joint Test Action Group (JTAG) Test Access Port (TAP) appears in some processor designs (although processor vendors sometimes omit TAP functionality from simulation models such as the detailed processor model 130). The TAP can be used to extract state information from the model 130. However, this approach is sometimes relatively slow.

In other embodiments, the tracking ISS 172 tracks the program counter in the detailed processor model 130 (as the model 130 simulates execution of a portion of the program) and passes this information to the fast processor model 140. This allows the fast processor model 140 to execute the same instructions as the detailed processor model 130 at about the same time and generally maintain the same state as the detailed processor model 130 (i.e., both models operate “in parallel”). In some cases the detailed processor model 130 can execute one or more instructions that cannot be observed by the fast processor model 140. For example, if the detailed processor model 130 performs a load operation from a hardware I/O port (e.g., an operation that interacts with the additional hardware models 170), the operation is not necessarily visible to the fast processor model 140. However, in some embodiments the tracking ISS 172 notes when such an operation is executed and compares the state of the operation's target register in the fast processor model 140 with the state of the corresponding register in the detailed processor model 130. If these two registers contain different values, the value from the target register in the detailed processor model 130 is written to the corresponding register in the fast processor model 140. In further embodiments, one ISS performs the functions of both the ISS 150 and the tracking ISS 172.

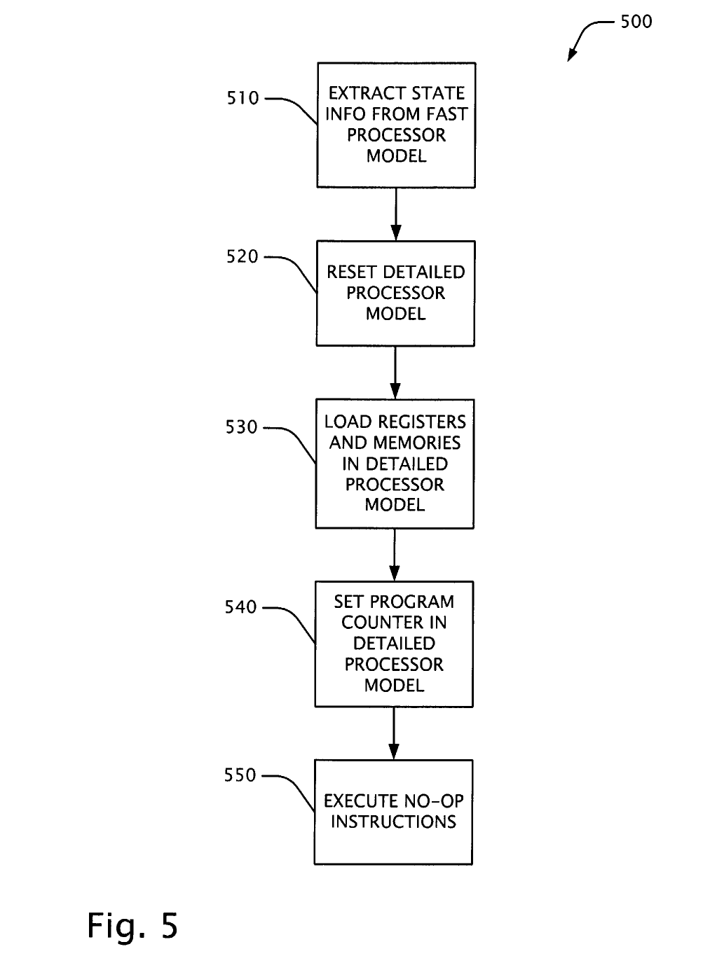

FIG. 5 shows a block diagram of an exemplary method 500 for transferring state information 310 from a fast processor model 140 to a detailed processor model 130 (e.g., as in FIG. 3). In a method act 510, state information 310 is extracted from the fast processor model 140. In a method act 520 the detailed processor model 130 is reset to a known state where the model 130 executes a program for loading state information. The program functions in cooperation with a loading circuit model 132 to load values into one or more registers and/or one or more memories in the detailed processor model 130 in a method act 530. In some embodiments, the registers include, for example, coprocessor registers and/or general purpose registers. In additional embodiments the memories can include caches, though in some cases loading a cache can be relatively slow. Additionally, the cache often does not affect the functional operation of the processor. The architectural state can be loaded into the detailed processor 130 using, for example, one or more software programs. For example, these one or more programs comprise a series of register load operations that set one or more registers in the detailed processor model 130 to one or more values extracted from the fast processor model 140. The program counter in the detailed processor model 130 is set in a method act 540. This can, in at least some embodiments, be accomplished using a branch instruction. In particular embodiments, the program counter is set to a value indicating N instructions before a desired instruction that the detailed processor model 130 is to execute, where N is the depth of the pipeline in the models 130, 140. In a method act 550, the detailed processor model 130 executes one or more no-op instructions (e.g., N no-op instructions). This can effectively “flush” the state of the execution pipeline in the detailed processor model 130. In embodiments where a no-op instruction is not defined in the instruction set, an instruction with no side effects can be used (e.g., an instruction that adds 0 to a register, or an instruction that ORs a register with itself). In some embodiments, the detailed processor model 130 is decoupled from the demultiplexers 116 and/or the multiplexer 118 while one or more of the no-op instructions are executing and then recoupled. After the execution of the method act 550, the state of the detailed processor model 130 will allow the model 130 to correctly execute the program simulated as running on the circuit design.

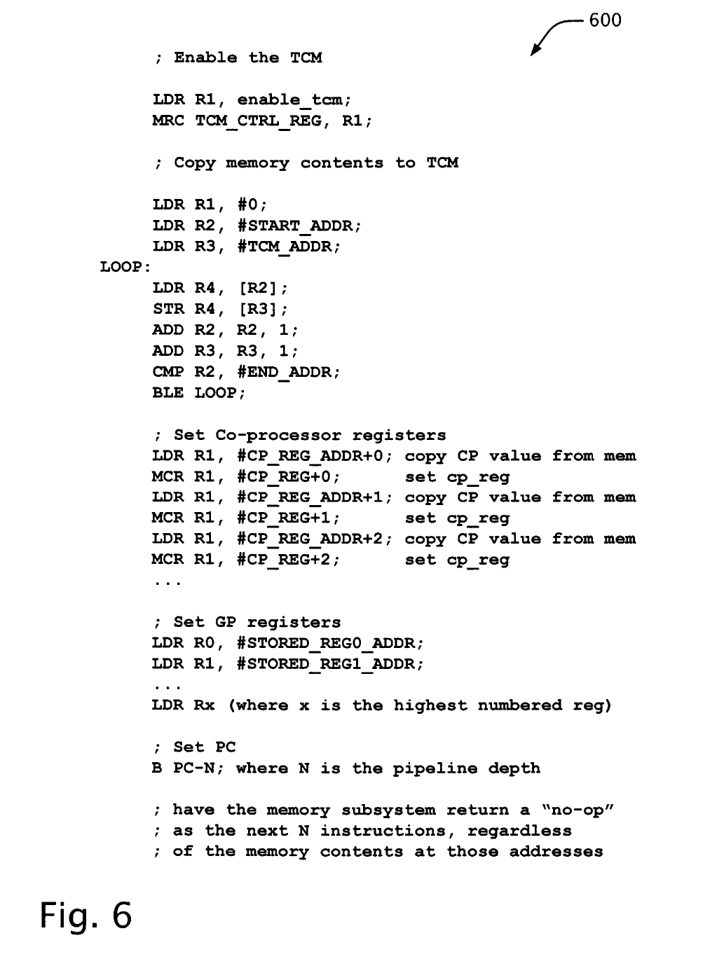

FIG. 6 shows a pseudocode example of one embodiment of a computer program 600 that can be used to perform at least a portion of the method 500. This particular embodiment of the program 600 is written in a simplified version of the assembly code used in ARM processors.

In some embodiments, a transfer of state information from one processor model to another can occur after the simulated execution of any instruction in the software program. In further embodiments, in at least some cases a state information transfer occurs only at “safe” points when certain instructions are not being executed (e.g., are not in the pipeline of one of the processor models). Such instructions can include, for example, instructions that affect data or operations in one or more hardware components. In some embodiments, state information cannot be transferred from the detailed processor model 130 to the fast processor model 140 while a memory transaction is “in flight” (i.e., when the detailed processor model 130 has started, but not yet completed, a memory transaction), as this can potentially result in an inconsistent state between the two models. By observing one or more signals on the detailed processor model 130 (e.g., one or more pins or ports), it can be determined whether a memory transaction is in flight. In some embodiments, memory transactions from the detailed processor model 130 can be inhibited by asserting one or more signals (e.g., a bus-grant or similar signal) on the model 130.

Additional embodiments are configured to transfer state information from a first model to a second model under a first set of conditions and to transfer state information from the second model to the first model under a second set of conditions. For example, in some embodiments state information is transferred from the fast processor model 140 to the detailed processor model 130 after the simulated execution of any instruction in the software program, but state information is transferred from the detailed processor model 130 to the fast processor model 140 only at one or more “safe” points (e.g., as described above). In select embodiments, state information is transferred at one or more points defined at least in part by user input.

In some cases, a given value A is stored in the processor model 110 at a location X in one or both of the models 130, 140. However, within a predetermined number of clock cycles the value at X will change to B. Some embodiments of the system 100 comprise a “peek-ahead” feature that alerts the monitoring program 120 that the value at location X will change and/or what the value will change to.

In additional embodiments, the system 100 can be configured to simulate the execution of one or more software programs successively (e.g., in a “batch” mode).

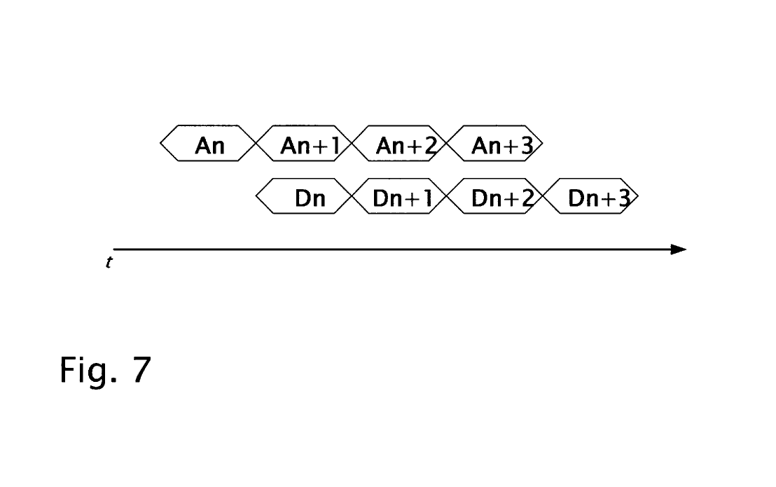

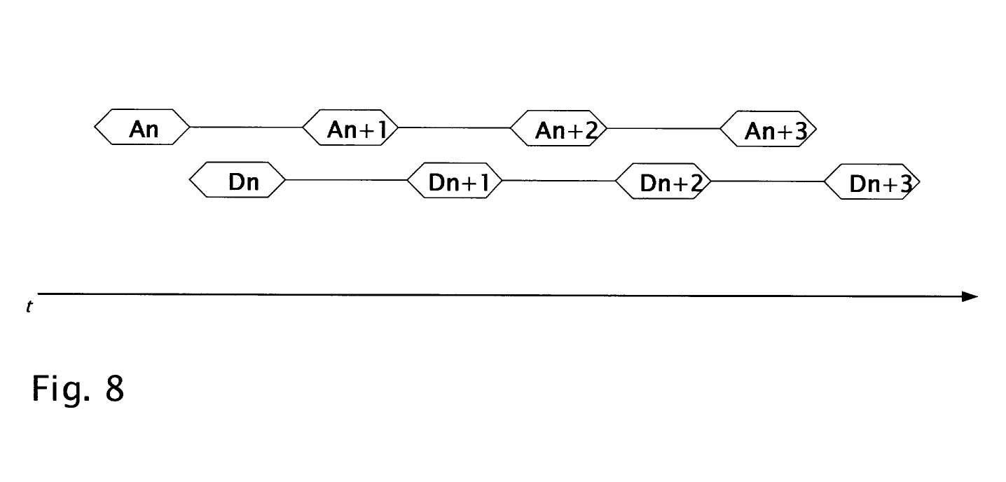

The functioning of the BCE 160 can vary in different embodiments. For example, in some embodiments the address and data phases of bus cycle interactions are maintained over a time t, as shown in FIG. 7, such that the address phase for a bus cycle n+1 occurs simultaneously with a data phase for a bus cycle n. While this approach generally accurately depicts the functioning of an actual processor, the implementation of a BCE with this approach can be relatively complicated. FIG. 8 shows another approach, where the address and data phases for a bus cycle n occur consecutively before address and/or data phases for a cycle n+1 are executed. This approach is generally simpler to implement than the approach depicted in FIG. 7, and in some cases provides sufficient accuracy for simulation purposes.

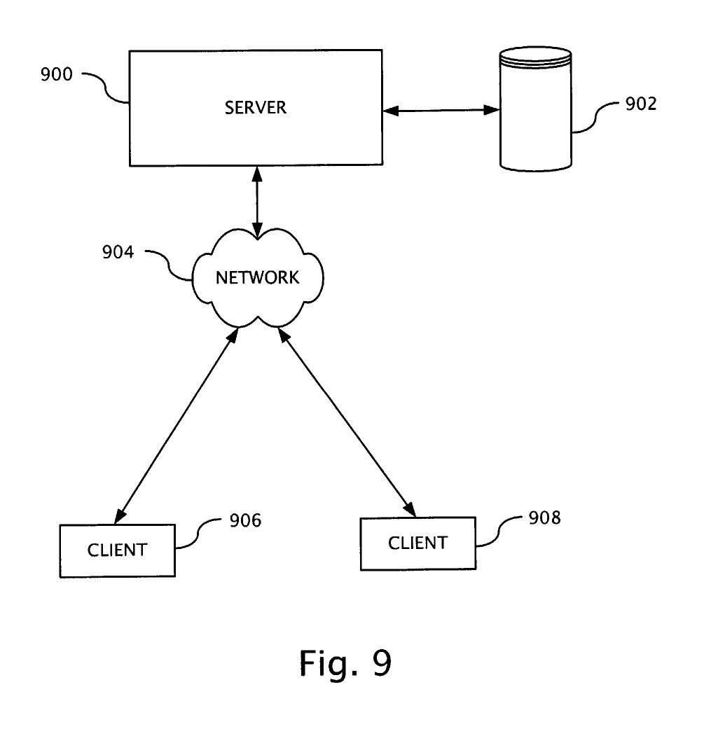

Any of the aspects of the technologies described above may be performed using a distributed computer network. FIG. 9 shows one suitable exemplary network. A server computer 900 can have an associated storage device 902 (internal or external to the server computer). For example, the server computer 900 can be configured to perform any of the disclosed simulation embodiments for a given circuit-under-test (for example, as part of an EDA software tool). The server computer 900 can be coupled to a network, shown generally at 904, which can comprise, for example, a wide-area network, a local-area network, a client-server network, the Internet, or other suitable network. One or more client computers, such as those shown at 906, 908, can be coupled to the network 904 using a network protocol. The work can also be performed on a single, dedicated workstation, which has its own memory and one or more CPUs.

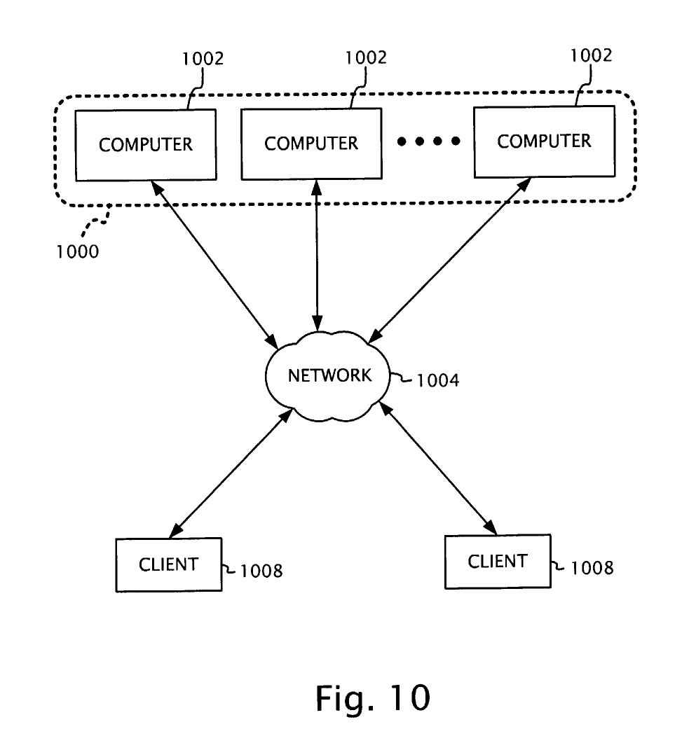

FIG. 10 shows another exemplary network. One or more computers 1002 communicate via a network 1004 and form a computing environment 1000 (for example, a distributed computing environment). Each of the computers 1002 in the computing environment 1000 can be used to perform at least a portion of the compactor generation process or diagnostic process. The network 1004 in the illustrated embodiment is also coupled to one or more client computers 1008.

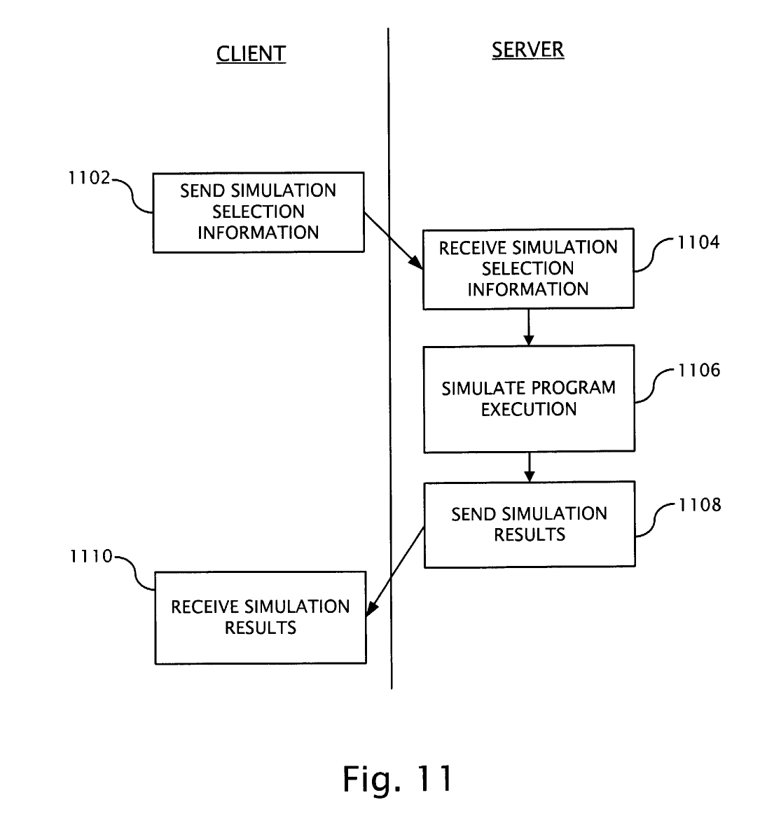

FIG. 11 shows that execution of a software program on a processor can be simulated using a remote server computer (such as the server computer 900 shown in FIG. 9) or a remote computing environment (such as the computing environment 1000 shown in FIG. 10) in order to generate simulation results. At process block 1102, for example, the client computer sends simulation selection information to the remote server or computing environment. In process block 1104, the simulation selection information is received and loaded by the remote server or by respective components of the remote computing environment. In process block 1106, program execution is simulated according to the received simulation selection information. At process block 1108, the remote server or computing environment sends the simulation results to the client computer, which receives the data at process block 1110.

The embodiment shown in FIG. 11 is not the only way to generate simulation results using the disclosed embodiments with multiple computers. For instance, the simulation selection information can be stored on a computer-readable medium that is not on a network and that is sent separately to the server or computing environment (for example, a CD-ROM, DVD, or portable hard drive). Or, the server computer or remote computing environment may perform only a portion of the simulation procedures. In further embodiments, electronic circuit design information and/or software programs (e.g., for simulated execution on one or more electronic circuit designs and/or processors) can be transmitted to the server or computing environment along with or in place of the simulation selection information.

Having illustrated and described the principles of the disclosed technologies, it will be apparent to those skilled in the art that the disclosed embodiments can be modified in arrangement and detail without departing from such principles. In view of the many possible embodiments, it will be recognized that the illustrated embodiments include only examples and should not be taken as a limitation on the scope of the invention. Rather, the invention is defined by the following claims and their equivalents. We therefore claim as the invention all such embodiments and equivalents that come within the scope of these claims.

We claim:

1. A method of simulating execution of a software program by a processor having one or more output pins, the method comprising:
simulating execution of a first portion of the software program using a first model of the processor, wherein the first model operates with a first degree of abstraction of the processor and is configured to simulate generation of a first set of signals on the one or more output pins;
simulating execution of a second portion of the software program using a second model of the processor, wherein the second model operates with a second degree of abstraction of the processor and is configured to simulate generation of a second set of signals on the one or more output pins, and wherein the first degree of abstraction is more abstract than the second degree of abstraction; and
storing at least a portion of the first or second set of signals on the one or more output pins in one or more computer-readable media.

2. The method of claim 1, further comprising passing state information between the first model of the processor and the second model of the processor.

3. The method of claim 2, wherein the passing of state information occurs when the second model of the processor is not simulating the execution of an instruction that affects one or more hardware components external to the second model.

4. The method of claim 2, wherein the passing of state information comprises loading data from the first model of the processor into storage locations of the second model of the processor.

5. The method of claim 4, wherein the passing of state information further comprises:
resetting the second model of the processor to a known state; and
setting a program counter in the second model of the processor to a selected value.

6. The method of claim 1, further comprising providing to the first model of the processor information about one or more operations performed by the second model of the processor during the simulating of the second portion of the software program.

7. The method of claim 1, wherein the first level of abstraction disregards at least some clock-edge timing information for the processor.

8. The method of claim 1, further comprising:
reading state information from the second model of the processor using an instruction set simulator; and
providing the state information from the instruction set simulator to the first model of the processor.

9. The method of claim 1, further comprising identifying the first portion of the software program and the second portion of the software program based at least in part on user input.

10. The method of claim 1, further comprising displaying the first or second set of signals on the one or more output pins to a user.

11. The method of claim 10, wherein the displaying the first or second set of signals on the one or more output pins to a user comprises:
determining that a value in a selected storage location will change from a first value to a second value within a predetermined number of clock cycles; and
displaying the second value.

12. The method of claim 1, wherein the processor is simulated as being coupled to one or more additional electronic components in an electronic circuit design.

13. One or more computer-readable media comprising the first or second set of signals on the one or more output pins produced according to the method of claim 1.

14. A system for simulating execution of a software program in a processor comprising one or more output pins, the system comprising:
a first model of the processor configured to simulate execution of the software program at a first level of detail, wherein the first model of the electronic circuit is configured to simulate signals produced by the processor at the one or more output pins;
a second model of the processor configured to simulate execution of the software program at a second level of detail, wherein the second model of the electronic circuit is configured to simulate signals produced by the processor at the one or more output pins; and
a software component configured to display the one or more results produced according to the first model or the second model.

15. The system of claim 14, further comprising a simulation selection component configured to receive an indication of whether execution of a portion of the software program is to be simulated according to the first model of the processor or the second model of the processor.

16. The system of claim 15, further comprising a remote computer, wherein the simulation selection component is configured to receive the indication from the remote computer over a network.

17. The system of claim 14, wherein the first model of the processor comprises an instruction set simulator and a bus cycle engine.

18. The system of claim 17, wherein the bus cycle engine simulates completion of execution of a first-bus-cycle address phase and a first-bus-cycle data phase before simulating beginning of execution of a second-bus-cycle address phase or a second-bus-cycle data phase.

19. The system of claim 14, wherein the second model of the processor comprises a register transfer level or gate level model.

20. The system of claim 14, wherein the first model of the processor is configured to simulate the execution of the software program at the rate of at least about 1 million instructions per second.

21. One or more computer-readable media comprising instructions configured to cause a computer to perform a method comprising:
receiving input from a user that execution of a first portion of a software program by a processor is to be simulated at a first level of detail and that execution of a second portion of the software program is to be simulated at a second level of detail;
simulating the execution of the first portion of the software program at the first level of detail using a first model of the processor;
simulating the execution of the second portion of the software program at the second level of detail using a second model of the processor; and
storing at least a portion of the results of the simulations of the executions of the first or second portions in one or more computer-readable media.

22. The one or more computer-readable media of claim 21, further comprising instructions configured to cause the computer to perform the method for each of a plurality of software programs.

23. A method of simulating operation of a processor, the method comprising:
receiving state information from a first processor model;
loading the state information into one or more storage locations in a second processor model; and
simulating executing a portion of a software program on the second processor model.

24. The method of claim 23, wherein the second processor model comprises a pipeline, the method further comprising simulating executing one or more instructions to flush the pipeline.

25. The method of claim 24, wherein the simulating executing one or more instructions to flush the pipeline comprises simulating executing one or more no-op instructions.

26. The method of claim 23, further comprising resetting the second processor model to a known state.

27. The method of claim 23, further comprising setting a program counter in the second processor model.

28. One or more computer-readable media comprising instructions configured to cause a computer to perform the method of claim 23.

29. A method of analyzing execution of a software program by a processor, the method comprising:
executing a first portion of the software program using equivalent hardware to generate a first set of output data;
transferring processor context information between the equivalent hardware and a model of the processor;
simulating execution of a second portion of the software program using the model of the processor, wherein the second model operates with a degree of abstraction of the processor and is configured to simulate generation of a second set of output data; and
storing at least a portion of the first or second set of output data in one or more computer-readable media.

30. The method of claim 29, wherein the equivalent hardware comprises the processor in a host computer.

31. The method of claim 29, wherein the equivalent hardware comprises an emulator.
